(19) United States
(12) Patent Application Publication
(10) Pub. No.: US 2012/0173622 A1
(43) Pub. Date: Jul. 5, 2012

(54) SOCIAL SCREEN CASTING

(75) Inventors: Eyal Toledano, Kiryat Ata (IL); Reuben Bareli, Herzliya (IL); Elad Haviv, Zurit (IL); Dan Shirron, Givaat Ada (IL); Dror Tirosh, Raanana (IL)

(73) Assignee: SAMSUNG ELECTRONICS CO., LTD., Gyeonggi-do (KR)

(21) Appl. No.: 12/983,954

(22) Filed: Jan. 4, 2011

(51) Int. Cl. G06F 15/16; H04W 88/02

(52) U.S. Cl. 709/204; 455/566

(57) ABSTRACT

A system for allowing the sharing of content available on the screen of a first user's mobile device with a second user, collectively comprises: i) A Screen Casting Engine, suitable to capture the screen of a first mobile device operating as a streamer device, and to send it to other mobile devices or computers over wireless network; ii) Stream Management Circuitry provided in said streamer device, which is suitable to direct the captured screens to multiple targets; iii) Key and touch injection engine, which is suitable to capture key events from a player mobile device or PC, and to send them back to the streamer; and, optionally iv) Social feedback software which allows two phone users to interact—one holding the streamer phone, and the other viewing his display by running a player.

### FIELD OF THE INVENTION

The present invention relates to the field of telecommunication. More particularly, the invention relates to a method and a system for permitting to share the screen of a user device with one or more additional users employing a separate device.

### BACKGROUND OF THE INVENTION

The invention relates to any device that possesses a screen and communication capabilities, such as cellular phones, PDAs and laptops. Because of its widespread use, and for the sake of brevity, the following description and explanations will make reference to “mobile phone” as the representative device, it being understood that the term is to be interpreted broadly to embrace any and every mobile device provided with a screen and with communication capabilities.

The mobile phone is a major platform on which people spend a lot of time working with applications. Yet, the phone's screen is small, and is suitable mainly for one person's view. Sometimes, however, a number of persons want to view the screen simultaneously. Examples of such cases may include gaming sessions, web browsing, running native applications of the phone, etc. However, to date the art has failed to provide efficient means and complete user experience that enable the creation of a shared screen display and the ability to provide feedback to a streaming device (i.e., the device the screen of which it is desired to share).

The art has addresses problems in this field from several directions and, therefore, many remote access applications have been released. These include:

### 1. Remote Computer Desktop Applications

These applications allow taking control of a computer from another computer on the network. An example is the Microsoft Remote Desktop, which allows to connect from one PC to another. Another example is the free solution VNC, which is available for all major operating systems. VNC allows controlling the display of one computer accessed from another, even if that other computer is running a different operating system. VNC implementations are being developed also for mobile phones like iPhone and Android.

### 2. Remote Desktop Services

There are various services that use this technology. These are no longer limited to a computer in the network, but allow a person to connect to other computers, regardless of where they are on the Internet. Examples of such services include LogMeIn and GotoMyPC. A list of various software and services for remote access is currently available from http://en.wikipedia.org/wiki/Comparison_of_remote_desktop_software

### 3. Conferencing Tools

There are various conferencing tools which provide screen sharing as one of the “shared media” during the conference, such as NetMeeting, WebEx, AT&T Connect, and more.

### 4. Phone Remote Control

A set of tools is targeted explicitly to allow controlling a phone device from a desktop computer. This includes the Android screen cast and the Veency-iPhoneVNC server. Solutions are also available for Windows Mobile, such as http://www.mymobiler.com/, and for Blackberry http://www.bomgar.com/mobile/.

Most of the above solutions were not created specifically for mobile devices i.e., phone screen casting, but rather the phone was used only as a viewer for a session on a computer. Few attempts were made to cast the phone display in a limited stream quality of about 2-5 frames per second. Furthermore, the abovementioned phone remote control solutions are aimed at viewing the phone from a desktop computer, not for sharing between multiple users including phone users.

One of the severe drawbacks of prior art solutions is the capture and compression of the displayed screen. Prior art solutions use software, and thus must either consume high level CPU to compress (and thus interfere with running application), or not compress to video—only take snapshot images. This causes high bandwidth usage, and low frame rate. As a result, existing solutions are inadequate for real-time, media-rich applications, such as games, and video.

In PC applications, the large screen allows the users to have a chat window to allow interaction between the remote users. However, phone applications do not have any means for allowing access for a remote user to interact with the local user. Accordingly, the art has so far failed to provide a real-time, low-latency screen sharing application between mobile phones, which is suitable to enable features such as social feedback, support for one-to-many casting of mobile screens and sharing of the screen of smart-phones with other phones.

### SUMMARY OF THE INVENTION

The invention relates to a system for allowing the sharing of content available on the screen of a first user's mobile device with a second user, collectively comprising:
i) A Screen Casting Engine, suitable to capture the screen of a first mobile device operating as a streamer device, and to send it to other mobile devices or computers over wireless network;
ii) Stream Management Circuitry provided in said streamer device, which is suitable to direct the captured screens to multiple targets;
iii) Key and touch injection engine, which is suitable to capture key events from a player mobile device or PC, and to send them back to the streamer; and, optionally
iv) Social feedback software which allows two phone users to interact—one holding the streamer phone, and the other viewing his display by running a player.

According to an embodiment of the invention the Stream management circuitry provided in the streamer device is not limited to sharing with other devices, but also suitable to save a local file, or to upload it as a video stream to a server for later viewing. According to another embodiment of the invention the streamer injects the events that the Key injection engine has captured from a player phone or PC to the phone, thereby effectively allowing the player phone or PC not only be a viewer of the display, but also to control the streamer phone.

The system of the invention may comprise two or more mobile devices, each of which mobile devices is provided with a Screen Casting Engine, Stream Management Circuitry, and a Key injection engine, and wherein any participating mobile device can operate as a streamer. In one embodiment of the invention at least one of the mobile devices is a cellular phone.

The invention is also directed to a mobile device comprising:
(a) A Screen Casting Engine, suitable to capture its screen when the mobile device operates as a streamer device, and to send it to other mobile devices or computers over wireless network;
(b) Stream Management Circuitry provided therein, which is suitable to direct the captured screens to multiple targets;
(c) A Key injection engine, which is suitable to capture key events from the device when it operates in a player mode, and to send them back to the streamer; and, optionally
(d) Social feedback software which allows two phone users to interact—one holding the streamer phone, and the other viewing his display by running a player.

According to an embodiment of the invention the mobile device is a mobile phone.

The invention also encompasses a method for allowing the sharing of content available on the screen of a first user's mobile device with a second user by using the system of the invention.

### BRIEF DESCRIPTION OF THE DRAWINGS

In the drawings:

FIG. 1 schematically illustrates a method for inviting another person to view a local screen, according to one embodiment of the invention;

FIG. 2 schematically illustrates the operation of the Screen Casting Application (SCA);

FIG. 3 is an example of projector sharing according to one embodiment of the invention;

FIG. 4 illustrates desktop casting;

FIG. 5 illustrates collaborative browsing;

FIG. 6 illustrates as a number of persons watch video together on separate devices;

FIG. 7 is an example of a remote assistant session-initiating message;

FIG. 8 is an example in which a user shares the game he is playing with another user; and

FIG. 9 is an example of performing a session “flip”.

### DETAILED DESCRIPTION OF THE INVENTION

The invention comprises multiple components:
1) A screen casting engine, which captures the screen of a mobile phone (hereinafter referred to also as the “streamer” device) and sends it to other phones or computers over wireless network.
2) Stream management circuitry provided in the streamer device, which is suitable to direct the captured screens to multiple targets, not limited to sharing with other devices, but also suitable to save a local file, or to upload it as a video stream to a server for later viewing.
3) Key injection engine, which is suitable to capture key events from a player phone or PC, and to send them back to the streamer. The streamer injects the events to the phone, which effectively allows the player phone or PC not only be a viewer of the display, but also to control the streamer phone.
4) Social feedback software which allows two phone users to interact—one holding the streamer phone, and the other viewing his display by running a player.

The invention enables the stream viewers to send feedback that will be displayed as pop-up balloons, that may be translucent, on the streamer's device at minimum latency. This feedback does not interfere with the running application, but instead it is a visual cue (such as android “Toasts”) for gestures such as “thumb up” or “thumb down” (i.e. gestures that other people can easily send in real-time). Illustrative examples of such gestures are:
Thumbs up: good work.
Thumbs down: not good. I'd suggest otherwise . . .
Question: I didn't understand what you've just did. Can you explain/elaborate/repeat?
Emoticons: [symbol] , etc
Raise Hand: please let me speak (using voice or text chat)

### Methods for Inviting a User to a Screen Cast Session

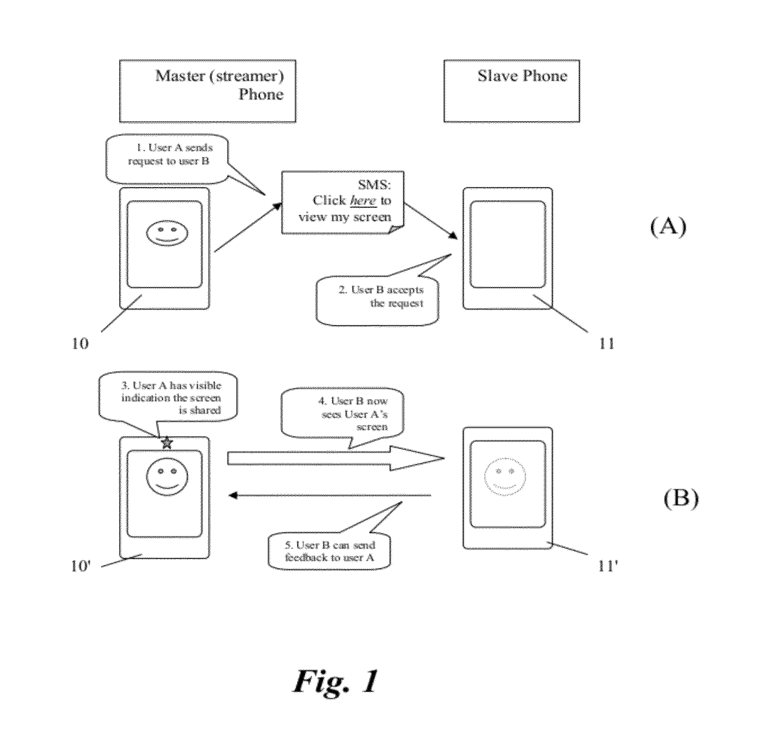

There are various methods for inviting another person to view the local screen one of which is schematically illustrated in FIG. 1. In FIG. 1A the User A of Master (streamer) phone 10 sends an SMS to User B's phone 11, with an invitation to share his phone screen with him. By clicking the link provided in the SMS, User B automatically connects to the streamer phone screen cast. Now that User B has clicked on the link, the streamer (indicated as 10′ in FIG. 1B) receives (in this particular example) an indication that the screen is shared. User B now sees the screen of phone 10′ on phone 11′ and can perform various activities, such as sending feedback to User A.

Of course, many other scenarios exist, for instance:
1. During a phone conversation, a user invites another person to watch his screen. The steps involved are:
   1) Start a phone call;
   2) During the phone call, the first user performs a “share my screen” (or “request your screen”) operation;
   3) The second user receives a notification, and accepts or rejects it;
   4) As in the SMS example of FIG. 1, now the second user can view the first user's screen.
2. LAN broadcast
   1) A first user selects “share my screen on the LAN”. As a result the screen casting engine makes the screen available over the LAN;
   2) Any user on the LAN can now connect and see the screen cast.
3. Public screen casting
The screen cast can be shared publicly on a network such as the Internet or on a server through the screen casting engine. In this mode, the other users must have other methods to find the casting session, e.g., by browsing on the server for such a session.
4. Share my app
Whenever a user runs specific application(s), other users (“friends” or “followers”) receive a notification, and can connect (either directly, or via a server) to the user to see him running the application in real-time

### Technical Explanation of the Screen Casting Application Operation

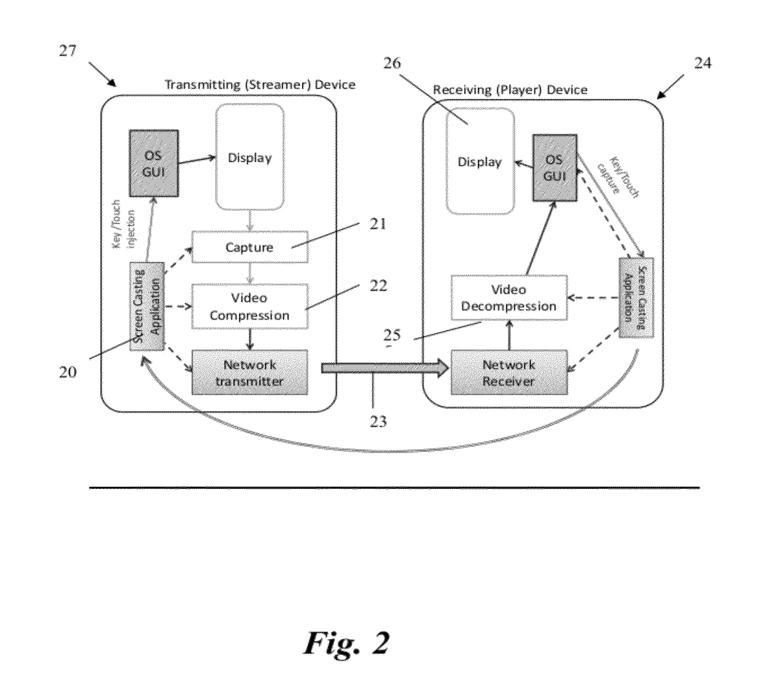

FIG. 2 schematically illustrates the operation of the Screen Casting Application (SCA).
1. In stage A, the SCA application 20 on the streamer phone 27 captures the current view directly from the screen hardware (frame buffer) 21 into the video compressor 22.
2. Compressed video is transmitted over the network 23.
3. The receiving side 24 uses its embedded video decoder hardware 25 for decompression.
4. The video can be displayed by directly decompressing the video to the device's physical screen 26 (or passed to the operating system for display).
5. In stage B, the receiving device 24, which runs a Key injection engine, has an option to capture local key and touch events, and to send them back to the streamer device.
6. The streamer device 27 uses OS/hardware and hooks to inject those keys into the running application.

By operating according to the invention the following technical features can be obtained, as will be easily apparent to the skilled person:
Physical-level frame rate: capture display changes at the modification rate (determined by the actual device from which the screen is captured.)
The dynamic frame rate depends on the available bandwidth.
Low computation delay, <5 ms (delay caused by actual encoding and decoding times)
Remote control: remote devices can control the streaming device's keys and touch screen.
Remote feedback: remote devices can send feedback to the user operating the phone (feedback is displayed to the user, but doesn't directly interfere with its work on the device.)
Network usage: devices operating according to the invention can use the best available network: WiFi for casting to local devices, or 3G network, to broadcast via a server.

The invention further allows for the implementation of viewer control keys. The viewing user, while watching and controlling the remote device, needs a way to stop the session and regain control of his own device. This can be done in several ways, such as by a special key or screen gesture that is not transmitted to the remote device, but instead operates locally (e.g by opening a menu of options to select from).

### Screen Casting Use Examples

### Example 1

### Projector Sharing

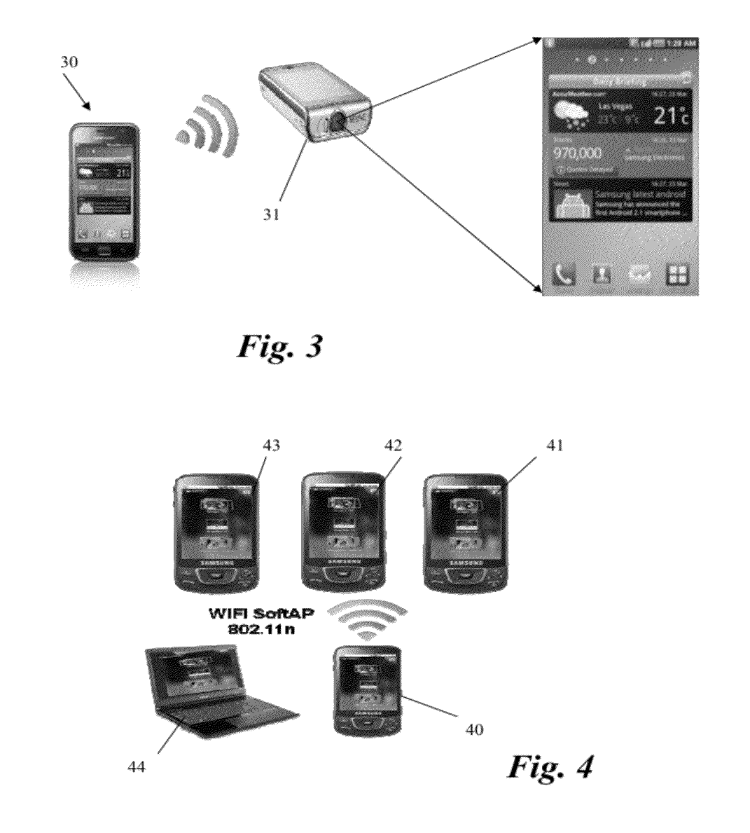

This example is illustrated in FIG. 3, and involves connecting to a projector using a WIFI LAN, instead of cables. The operation is performed as follows:
1) User 30 launches the screen casting application, and looks for projector 31 on the LAN;
2) User 30 connects to projector 31, to project the device's screen on the wall;
3) Projection can also be to a PC or directly to a TV.

### Example 2

### Desktop Casting

The local casting of specific application experience to multiple devices in parallel (with or without remote controls) is schematically shown in FIG. 4, which illustrates the casting by Phone 40 to three other phones (41-43) and to a laptop computer, 44. This application allows:
Local network easy setup;
Real-time screen casting;
Real-time social feedback;
Real-time remote controls;
Optional sharing of PC/Tablet users in the screen casting.

### Example 3

### Collaborative Browsing

The local casting web browsing experience to multiple devices in parallel (with or without remote controls) is schematically shown in FIG. 5, which illustrates the casting by Phone 50 to three other phones (51-53) and to a laptop computer, 54. This application allows for:
Local network easy setup;
Real-time screen casting;
Real-time social feedback;
Real-time remote controls;
Optional sharing of PC/Tablet users in the screen casting.

### Example 4

### Video Watching Together

The casting of a local Video or video out of the Internet such as YouTube by one device to other devices in real-time is schematically shown in FIG. 6, which illustrates the casting by Phone 60 to three other phones (61-63). As shown in the figure, the video doesn't have to be locally available to phone 60, but can be streamed to it, e.g., from YouTube (64). This application allows:
Real-time screen casting;
Real-time Audio Sync and control;
Real-time social feedback;
Optional sharing of PC/Tablet users in the screen casting.

### Example 5

### Multi User Experience

A multi-user experience can be, for instance, multiple users using multiple phones for a shared user experience. According to this embodiment of the invention more than just one “shared screen”, where both users see the same screen, are made available to the users. When working together with other people some of the time we share the same screen (one is working, the others are looking), but at other times we work on different tasks. Shared screen is a tool that allows users to have a working session together—some of the time on the same screen, and at some other times on different tasks. The following examples of use will illustrate the above.

### Flip Screen:

a. Any of the viewing users can select MENU/“Flip devices”. His device and the streamer's change their role, so the streamer becomes a viewer, and the viewer becomes a streamer to all viewers.
b. Optionally, after the switch, the previous viewer (and now the streamer) can launch the same application that was active previously on the streamer.
   1) If it's a browser, then it attempts to open the same URL that was open on the other phone's browser;
   2) If the application has another context, it will become the context of the new streamer application.
c. After the flip, the new viewer (which was previously the streamer) or any other viewer can switch back, to become a streamer.

### Split Work:

While a player watches the screen of the streamer user, he might want to “try it out” on his device. To do so, he can select MENU/Split. This will pause viewing the remote screen. Instead, it launches automatically the same application running on the streamer device locally, and attempts to put it in the same context as the remote application. Later on, the user may return to the screen casting session to continue viewing the screen of the streamer.

### PIP—Picture-in-Picture

While working locally the screen cast of the other devices is shown in a small window. This small window can be moved around (or hidden), so it will not interfere with local work.

At any given moment, that small remote screen can be “zoomed in”, to view the entire screen of that remote device.

### Show Streamer User Face

This is a variation of the picture-in-picture mode. When a user is a streamer, the front-facing camera is on. On his screen, in a small floating window, where he can see himself, or choose to hide it. The remote user thus can see the streamer screen casting, and also his face expression in a small floating window.

The streamer can move the small preview to a place on the screen where it doesn't interfere with the normal work. The remote viewer can move the preview or even enlarge it (if it is more important than viewing the screen), and see the remote screen cast as a small floating window. Face tracking is used to show only the face of the user, and to keep it steady.

### Remote Assistant

I this mode a user call for assistance from an expert friend, helpdesk, sibling, etc, in order to get assistance using his phone. The assistant connects to the user's phone, and shows the user how to operate it.

Key features:
1) Easy session establishment: The user might not be a power user and therefore needs a very easy way for “handshaking” using active phone call as data channel.
2) The user should be able to see the actual key touch of the assistant on his phone (“fingerprints”).
3) Remote PC control: The assistant should be able to assist users on different devices, so the assistant is using his PC to control the user's phone rather than a real mobile phone.

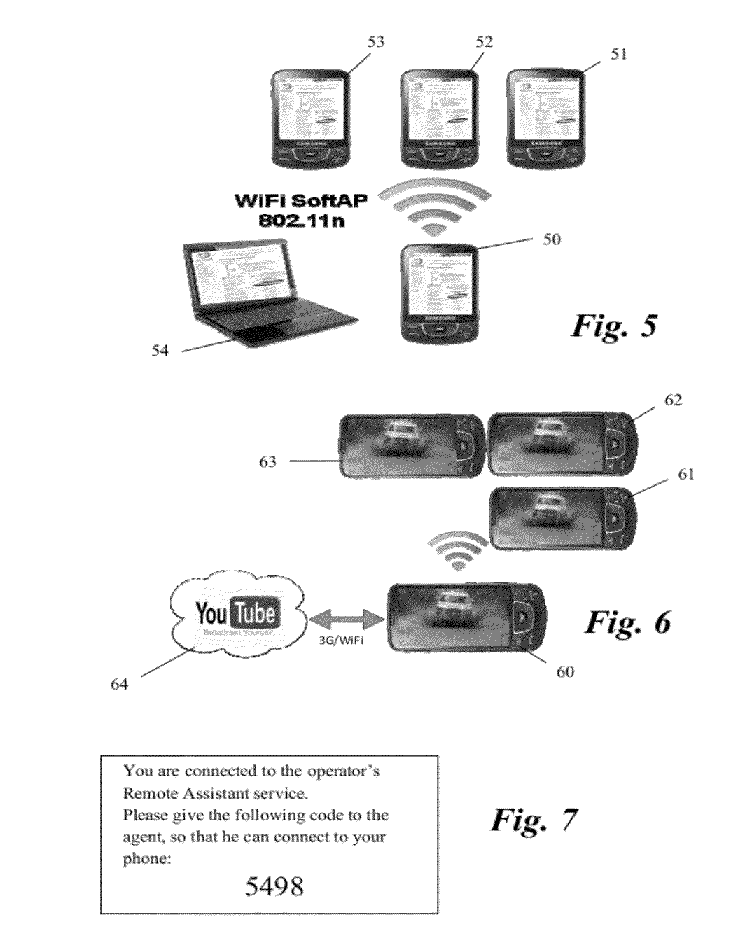

Example of a “help desk” scenario flow:
1. The user calls a call center (either using his cellular phone or not);
2. The CSR asks the user to run the “Remote Assistant” application;
3. The application connects to the operator's server, and shows a random 4-digit “session code”, as illustrated in FIG. 7;
4. The Agent asks the user for the session code, and enters it on his PC software;
5. When the agent connects to the user's phone, the user gets a message on the phone “Allow remote assistant?”;
6. The user click “Yes” to allow the agent use the phone;
7. Now the agent can see the screen of the phone.

### Security/Privacy Settings for the Screen Casting Application

Sharing a device's screen and keyboard requires some strict security settings, to make sure that only needed data is shared, and not private sensitive information. When such sensitive information is displayed on the streamer's screen, the other users will get a notification that the streamer has paused its streaming. Therefore, in different embodiments of the invention the following can be implemented:
Key/Touch control policy: the user can define for each viewer user the granted capabilities.
Bail-out key: Even when a remote user is in control of the local device, there is a “bail-out” key which immediately stops sharing the display and stops accepting remote keys. e.g., by pressing the “lock” button of the phone.
Streamer UI Indication: whenever the screen casting engine is active, there is a visible indication (see FIG. 1 as example) (which might also include information such as number of viewers, etc.)
Viewer UI indication: the viewing user will get a UI indication that he is currently viewing a remote device, and not his own device,
Black-listed applications: A list of applications that are never shared via screen casting—implying all other applications are available for sharing. By default, this list may include Messaging and the dialer application (as it is assumed that SMSs are something users don't want to share by default, and also don't want to share during incoming or outgoing calls). The user may add or remove applications from this list.
White-listed applications: If this list contains at least one application, then only the screen of these applications can be shared. It is possible that SCA is launched to share a specific application. Moving away from this application (either closing it, or another application popping up) will stop (or at least pause) the sharing session.
   When such a switch to another application occurs, the user can be asked whether he wants to continue sharing (adding current applications to the whitelist), and either allow this just for this instance of application launch, or permanently.
In order to enforce DRM protection, DRM protected content will not be played while the screen casting engine is active.

### Social App Sharing

One example of social application is getting notifications of a user's friends' activity with their phone. For example: “Dan has started playing “Pac Man”. Clicking this notification connects and actually allows to see in real-time his game, and to give him social feedback. If the user really likes the game he's playing he can download it with one click and launch it on his device.

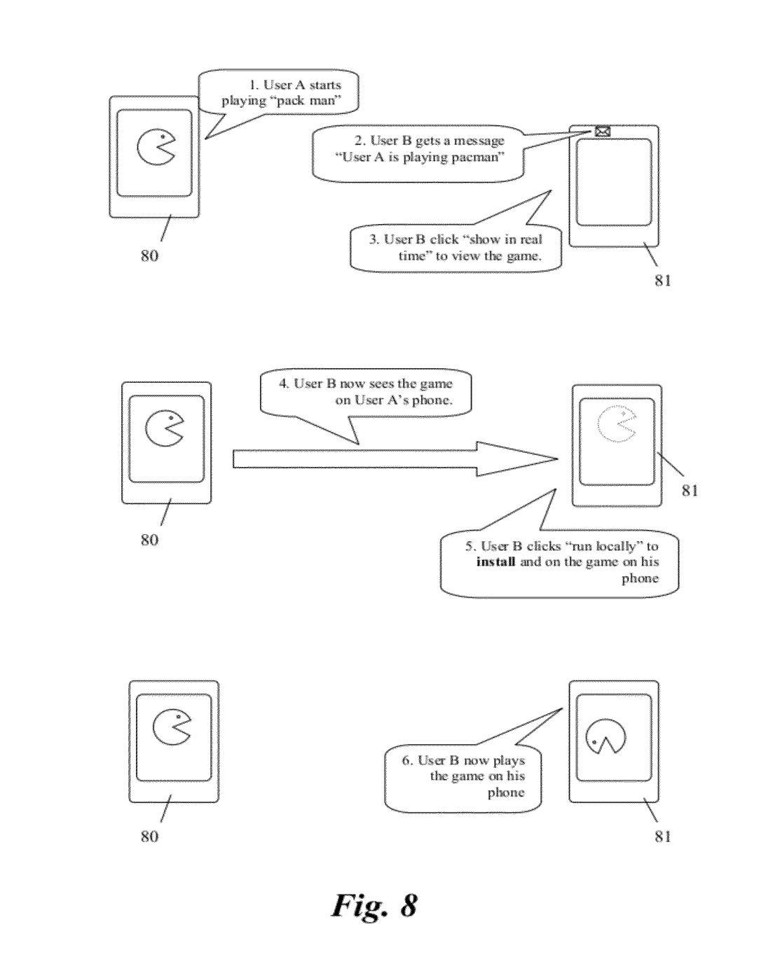

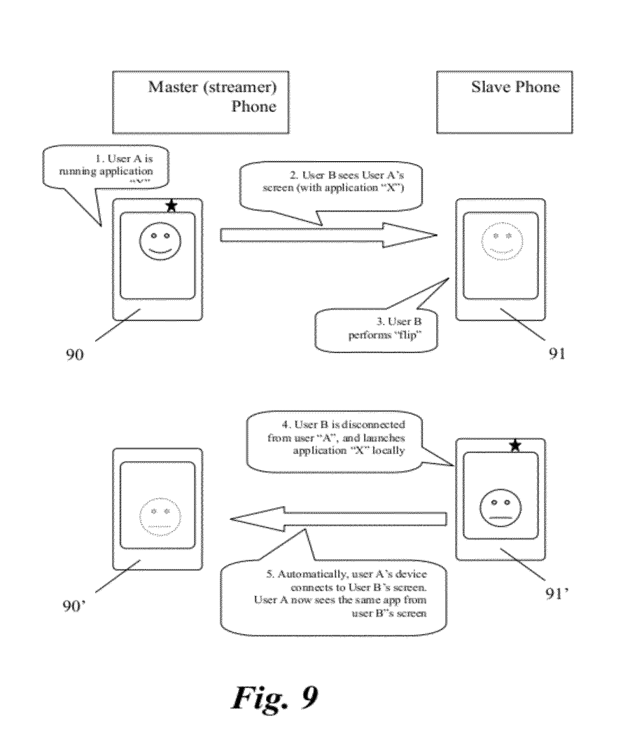

This is schematically illustrated in FIG. 8, where User A is the player playing on phone 80 and User B is notified on his phone, 81.

As will be apparent to the skilled person the invention can be implemented on a variety of mobile devices, using different platforms and is therefore not meant to be limited to any specific device or arrangement.

1. A system for allowing the sharing of content available on the screen of a first user's mobile device with a second user, collectively comprising:
(a) A Screen Casting Engine, suitable to capture the screen of a first mobile device operating as a streamer device, and to send it to other mobile devices or computers over wireless network;
(b) Stream Management Circuitry provided in said streamer device, which is suitable to direct the captured screens to multiple targets;
(c) Key and touch injection engine, which is suitable to capture key events from a player mobile device or PC, and to send them back to the streamer; and, optionally
(d) Social feedback software which allows two phone users to interact—one holding the streamer phone, and the other viewing his display by running a player.

2. A system according to claim 1, wherein the Stream management circuitry provided in the streamer device is not limited to sharing with other devices, but also suitable to save a local file, or to upload it as a video stream to a server for later viewing.

3. A system according to claim 1, wherein the streamer injects the events that the Key injection engine has captured from a player phone or PC to the phone, thereby effectively allowing the player phone or PC not only be a viewer of the display, but also to control the streamer phone.

4. A system according to claim 1, comprising two or more mobile devices, each of which mobile devices is provided with a Screen Casting Engine, Stream Management Circuitry, and a Key injection engine, and wherein any participating mobile device can operate as a streamer.

5. A system according to claim 1, wherein at least one of the mobile devices is a cellular phone.

6. A mobile device comprising:
(a) A Screen Casting Engine, suitable to capture its screen when the mobile device operates as a streamer device, and to send it to other mobile devices or computers over wireless network;
(b) Stream Management Circuitry provided therein, which is suitable to direct the captured screens to multiple targets;
(c) A Key injection engine, which is suitable to capture key events from the device when it operates in a player mode, and to send them back to the streamer; and, optionally
(d) Social feedback software which allows two phone users to interact—one holding the streamer phone, and the other viewing his display by running a player.

7. A mobile device according to claim 6, which is a mobile phone.

8. A method for allowing the sharing of content available on the screen of a first user's mobile device with a second user by using the system of claim 1.

9. The method of claim 8, wherein the content is shared on a projector using a WIFI LAN or the like wireless communication network.

10. The method of claim 8, comprising the local casting of a specific application experience to multiple devices in parallel, with or without remote controls.

11. The method of claim 8, which comprises collaborative browsing.

12. The method of claim 8, which comprises the casting of a video by one device to other devices in real-time.

13. The method of claim 12, wherein the video is locally available to the casting device.

14. The method of claim 13, wherein the video is streamed from a remote source.

15. The method of claim 8, wherein a multi-user experience is created by making available to the users more than one “shared screen”, where a plurality of users see the same screen.

16. The method of claim 15, wherein when working together with other users, a first user some of the time shares the same screen, while at other times different users work on different tasks.
